(19) United States
(12) Patent Application Publication
(10) Pub. No.: US 2011/0255587 A1
(43) Pub. Date: Oct. 20, 2011

(54) RECEPTION DEVICE AND SCRAMBLING CODE DECODING METHOD

(75) Inventors: Shimpei YOSHIKAWA, Kawasaki (JP); Mitsuru TOMONO, Kawasaki (JP); Makoto HAMAMINATO, Kawasaki (JP)

(73) Assignee: FUJITSU LIMITED, Kawasaki-shi (JP)

(21) Appl. No.: 13/085,672

(22) Filed: Apr. 13, 2011

(30) Foreign Application Priority Data
Apr. 15, 2010 (JP) 2010-94287

(51) Int. Cl. H04L 27/01

(52) U.S. Cl. 375/232

(57) ABSTRACT

A reception device includes: a channel estimation circuit to receive a first signal scrambled by one of N scrambling codes and transmitted through M carriers having different frequencies, and calculate N channel estimation values corresponding to N types of first specified signals based on the first signal, where N is an integer greater than or equal to 2, where M is an integer greater than or equal to 2; a channel equalization circuit to channel-equalize a second signal, which is transmitted using the one of N scrambling codes and the M carriers, based on the N channel estimation values; and a scrambling code decoding circuit to evaluate (N*M) equalized second signals based on N types of second specified signals and decode a scrambling code of the second signal from among the N scrambling codes.

### CROSS-REFERENCE TO RELATED APPLICATIONS

This application claims the benefit of priority from Japanese Patent Application No. 2010-94287 filed on Apr. 15, 2010, the entire contents of which are incorporated herein by reference.

### BACKGROUND

1. Field

The embodiments discussed herein relate to a reception device which decodes a scrambling code and a scrambling code decoding method.

2. Description of Related Art

Contents data scrambled on a transmitting side using a certain scrambling code is transmitted, and the contents data is decoded on a receiving side using the same scrambling code. For example, in a system that uses Media Forward Link Only (FLO) (registered trademark), before contents data is transmitted, the scrambling code transmitted from the transmitting side is decoded. In MediaFLO, multimedia contents are distributed to a mobile phone side. A related art is disclosed in Japanese Laid-open Patent Publication No. 2008-508814, Japanese Laid-open Patent Publication No. 2009-504031, Japanese Laid-open Patent Publication No. 2009-504033, or the like.

### SUMMARY

According to one aspect of the embodiments, a reception device includes: a channel estimation circuit to receive a first signal scrambled by one of N scrambling codes and transmitted through M carriers having different frequencies, and calculate N channel estimation values corresponding to N types of first specified signals based on the first signal, where N is an integer greater than or equal to 2, where M is an integer greater than or equal to 2; a channel equalization circuit to channel-equalize a second signal, which is transmitted using the one of N scrambling codes and the M carriers, based on the N channel estimation values; and a scrambling code decoding circuit to evaluate (N*M) equalized second signals based on N types of second specified signals and decode a scrambling code of the second signal from among the N scrambling codes.

The object and advantages of the invention will be realized and attained at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an exemplary subcarrier;

FIG. 2 illustrates an exemplary super frame;

FIG. 3 illustrates an exemplary signal point;

FIG. 4 illustrates an exemplary channel equalization;

FIG. 5A and FIG. 5B illustrate an exemplary transmission device and an exemplary reception device;

FIG. 6 illustrates an exemplary scrambling circuit;

FIG. 7 illustrates an exemplary scrambling circuit;

FIG. 8 illustrates an exemplary scrambling circuit;

FIG. 9 illustrates an exemplary channel estimation circuit, an exemplary equalization circuit, and an exemplary scrambling code decoding circuit;

FIG. 10 illustrates an exemplary decoding process;

FIG. 11 illustrates an exemplary channel estimation circuit, an exemplary channel equalization circuit, and an exemplary scrambling code decoding circuit;

FIG. 12 illustrates an exemplary channel estimation value;

FIG. 13 illustrates an exemplary distance between an ideal signal point and an equalized-signal point;

FIG. 14 illustrates an exemplary distance;

FIG. 15 illustrates an exemplary evaluation circuit;

FIG. 16 illustrates an exemplary distance calculation method;

FIG. 17 illustrates an exemplary scrambling circuit;

FIG. 18 illustrates an exemplary decoding process;

FIG. 19 illustrates an exemplary decoding process;

FIG. 20 illustrates an exemplary decoding process;

FIG. 21 illustrates an exemplary super frame reception process;

FIG. 22 illustrates an exemplary evaluation process;

FIG. 23 illustrates an exemplary evaluation process; and

FIG. 24 illustrates an exemplary evaluation process.

### DESCRIPTION OF EMBODIMENTS

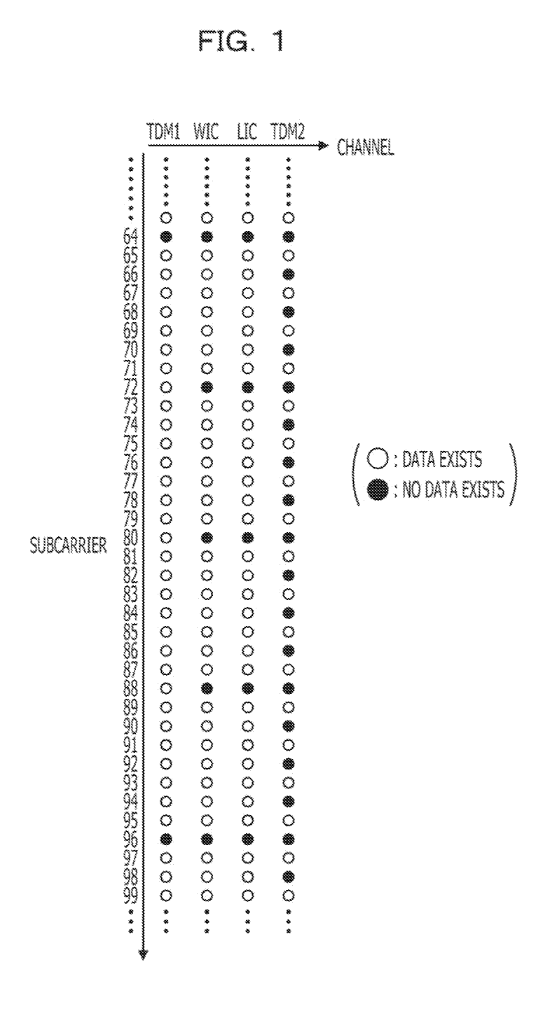

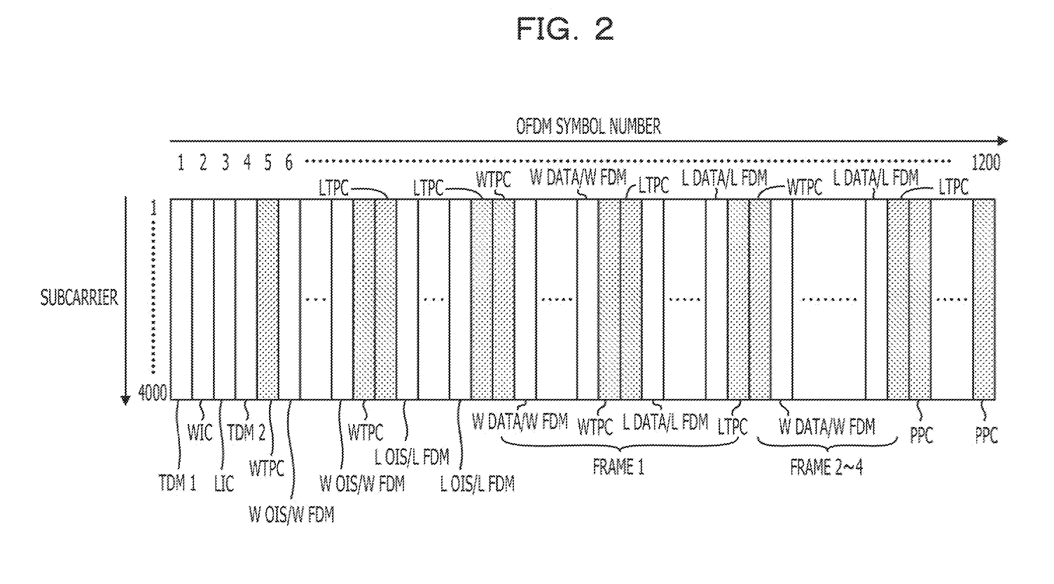

FIG. 1 illustrates an exemplary subcarrier. In MediaFLO, for example, an Orthogonal Frequency-Division Multiplexing (OFDM) signal having 4000 subcarriers is transmitted. FIG. 2 illustrates an exemplary super frame. As illustrated in FIG. 2, in MediaFLO, one super frame includes 1200 channels ranging from a 1st channel to a 1200th channel. The super frame includes a Time Division Multiplexing 1 channel (TDM1 channel), a Wide-area Identification Channel channel (WIC channel), a Local-area Identification Channel channel (LIC channel), a TDM2 channel, an OIS channel, a Data channel, or the like.

The TDM1 channel indicates the boundary of the super frame, for example, the start thereof, and may be used for the determination of the symbol timing of the OFDM signal, the estimation of a frequency offset, and the like. The TDM1 channel may be arranged at intervals of 32 subcarriers in the OFDM signal. For example, the signal of the TDM1 channel is transmitted using subcarriers having the subcarrier numbers from 64th to 96th.

The WIC channel is an identification channel used for wide-area broadcast, and includes a wide-area identification differentiator (WID). The WIC channel may be arranged at intervals of 8 subcarriers in the OFDM signal. For example, the signal of the WIC channel is transmitted using subcarriers having the subcarrier numbers 64th, 72th, 80th, 88th and 96th as illustrated in FIG. 1. The WID is used as a scrambling code.

The LIC channel is an identification channel used for local-area broadcast, and includes a local-area identification differentiator (LID). The LIC channel may be arranged at substantially the same intervals of subcarriers as those in the WIC channel in the OFDM signal. For example, the signal of the LIC channel is transmitted using subcarriers having the subcarrier numbers 64th, 72th, 80th, 88th, and 96th as illustrated in FIG. 1. The LID is used as a scrambling code for a local area.

The TDM2 channel is used for the symbol timing correction of the OFDM signal. The TDM2 channel may be arranged at intervals of 2 subcarriers in the OFDM signal. For example, in FIG. 1, the signal of the TDM2 channel is transmitted using subcarriers having the subcarrier numbers 64th, 66th, 68th, 70th, 72th, . . . , 94th, 96th, and 98th.

In MediaFLO, data scrambled on a transmitting side is descrambled on the receiving side using the WID. The WID includes 16 types, and which type of the WID is used is transmitted through the WIC channel located posterior to the TDM1 channel.

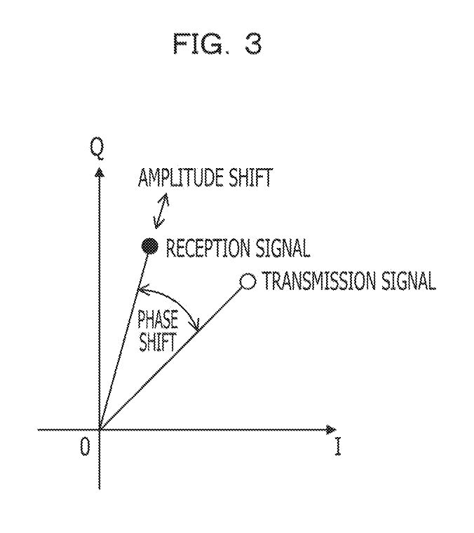

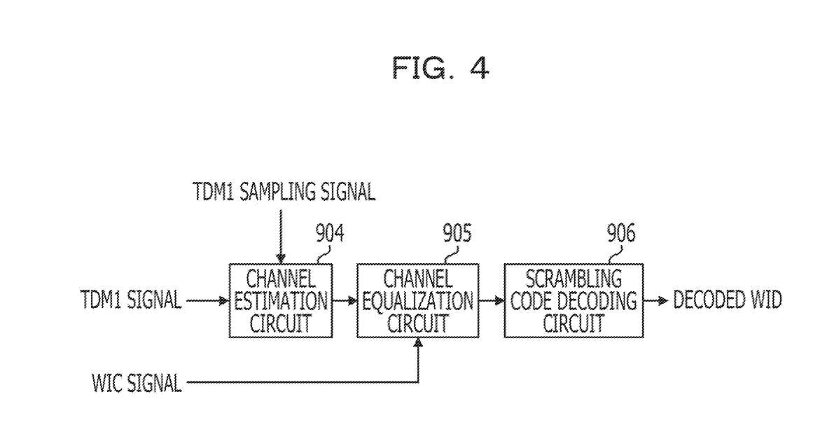

Owing to reflection or interference from a building, or the like, the amplitude or the phase of the TDM1 channel, the WIC channel, or the like may be changed. FIG. 3 illustrates an exemplary signal point. The signal point illustrated in FIG. 3 may be a signal point located in the first quadrant of a quadrature-modulated baseband. The amount of amplitude change and the amount of phase change of a reception signal point (which is referred as channel estimation values hereinafter) with respect to a transmission signal point may be calculated, for example, be channel-estimated. A white circle indicates the transmission signal point, and a black circle indicates the reception signal point. Using the channel estimation values, the reception signal point is restored to the transmission signal point, for example, is channel-equalized. The channel equalization may be performed for each subcarrier. FIG. 4 illustrates an exemplary channel equalization. A channel estimation unit 904 channel-estimates based on the reception signal of the TDM1 channel, and a channel equalization unit 905 channel-equalizes the reception signal of the WIC channel based on the channel estimation values. A scrambling code decoding unit 906 decodes a scrambling code (WID) from the channel-equalized WIC channel signal.

When the channel estimation is performed based on the subcarriers of the TDM1 channel which are arranged at intervals of 32 subcarriers and are transmitted anterior to the subcarriers of the WIC channel arranged at intervals of 8 subcarriers, one fourth of the subcarriers of the WIC channel may be used from among the subcarriers of the WIC channel, and remaining three fourths of the subcarriers of the WIC channel may not be used.

Using one scrambling code of a plurality of scrambling codes, transmission data is scrambled and transmitted. For example, a distribution technique used for contents data in MediaFLO may be used.

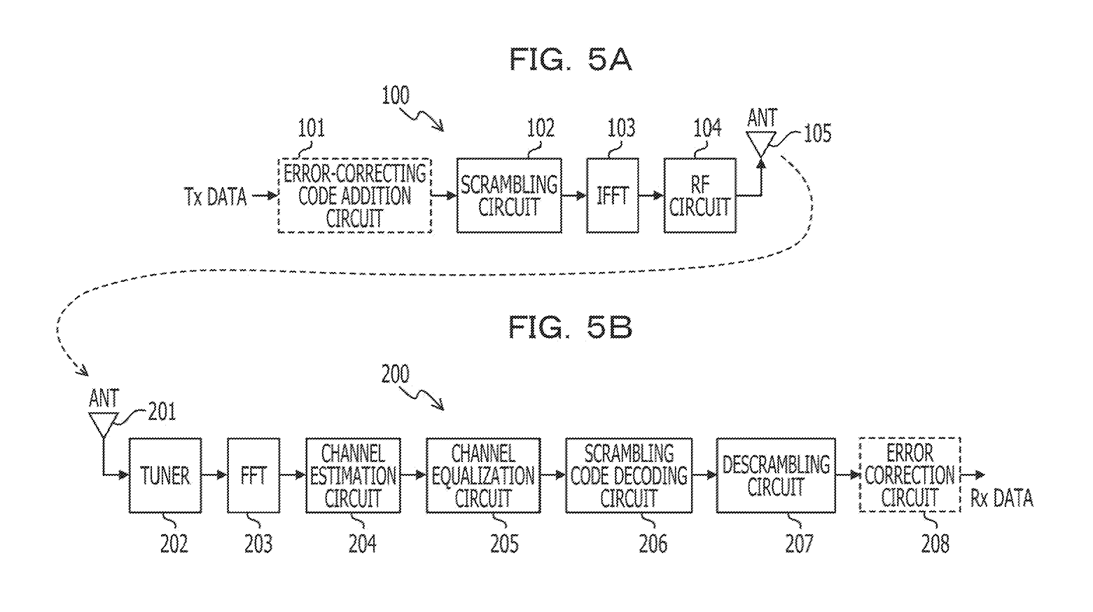

FIG. 5A and FIG. 5B illustrate an exemplary transmission device and an exemplary reception device. The transmission device and the reception device illustrated in FIGS. 5A and 5B, respectively, may be applied to MediaFLO.

A transmission device 100 illustrated in FIG. 5A includes an error-correcting code addition circuit 101, a scrambling circuit 102, an IFFT 103, an RF circuit 104, and an antenna (ANT) 105. The error-correcting code addition circuit 101 adds an error-correcting code to transmission data such as contents or the like, for example, Tx data. Using a certain scrambling code, the scrambling circuit 102 scrambles the transmission data to which the error-correcting code is added, for energy diffusion or the like. The IFFT 103 baseband-modulates data output from the scrambling circuit 102 into an OFDM signal including a plurality of subcarriers. The RF circuit 104 up-converts the baseband-modulated OFDM signal into a high-frequency signal for broadcasting. The ANT 105 radiates the up-converted high-frequency signal as a radio wave into space.

A reception device 200 illustrated in FIG. 5B includes an antenna (ANT) 201, a tuner 202, an FFT 203, a channel estimation circuit 204, a channel equalization circuit 205, a scrambling code decoding circuit 206, a descrambling circuit 207, and an error correction circuit 208. The ANT 201 receives the radio wave transmitted from the transmission device 100, and converts the radio wave into a high-frequency signal. The tuner 202 down-converts the high-frequency signal output from the ANT 201 into an OFDM signal corresponding to a baseband signal. The FFT 203 divides the OFDM signal output from the tuner 202 into each subcarrier, and outputs the subcarrier. The channel estimation circuit 204 estimates the distortion of a propagation channel for each subcarrier output from the FFT 203, and calculates a channel estimation value. The channel equalization unit 205 channel-equalizes the signal of each subcarrier based on the channel estimation value. The scrambling code decoding unit 206 decodes a scrambling code from the equalized signal output from the channel equalization unit 205. The descramble unit 207 descrambles the scrambled reception data using the decoded scrambling code. The error-correction unit 208 error-corrects the reception data descrambled based on the error-correcting code added on the transmitting side.

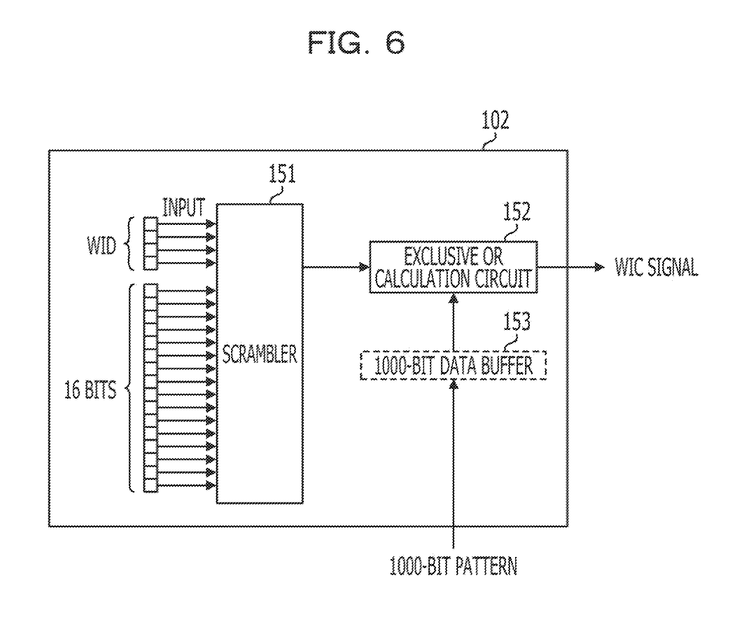

FIG. 6 illustrates an exemplary scrambling circuit. For example, when the transmission device 100 illustrated in FIG. 5A transmits the WIC channel, the scrambling circuit illustrated in FIG. 6 scrambles the data. The scrambling circuit 102 includes a scrambler 151, an exclusive OR calculation circuit 152, and a 1000-bit data buffer 153. The scrambler 151 generates a diffusion code which is used for energy-diffusing data input from the 1000-bit data buffer to the exclusive OR calculation circuit 152. A scrambling code (WID) and a 16-bit specified value for the WIC channel are input to the scrambler 151, and the diffusion code is generated based on a generator polynomial. The WID of the scrambling code may be 4 bits in length, and one of the 16 WIDs may be input. Certain 16 bits may correspond to the WIC channel, and a value “0” may be set in the 1000-bit data buffer when a channel is the WIC channel. The WIC channel generated in the scrambling unit 102 may includes 16 signals.

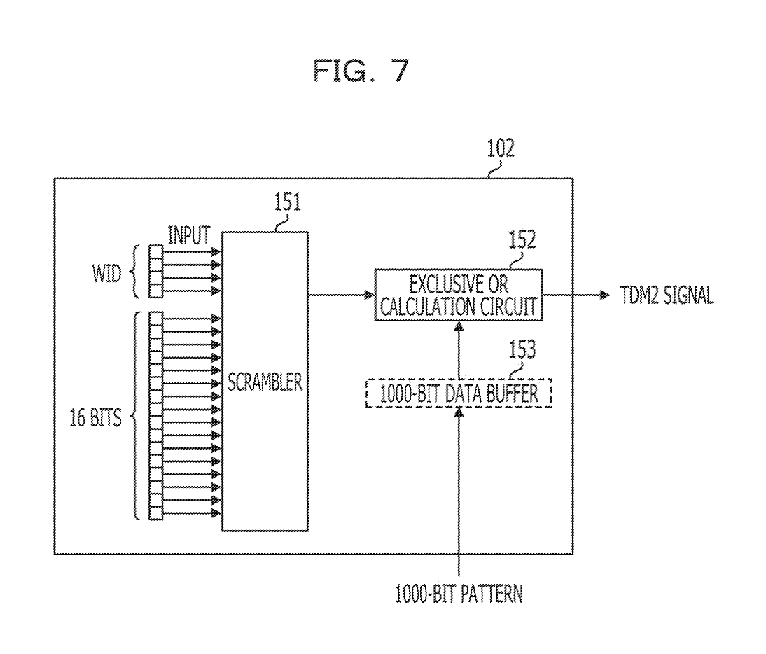

FIG. 7 illustrates an exemplary scrambling circuit. When the transmission device 100 illustrated in FIG. 5A transmits the TDM2 channel, the scrambling circuit illustrated in FIG. 7 scrambles the data. The elements of a scrambling circuit 102 illustrated in FIG. 7 may be substantially the same as or similar to those in the scrambling circuit illustrated in FIG. 6. A 16-bite value input to a scrambler 151 illustrated in FIG. 7 may be dedicated to the TDM2 channel. A value “0” may be set in a 1000-bit data buffer, and the TDM2 channel generated in the scrambling unit 102 may includes the same 16 signals.

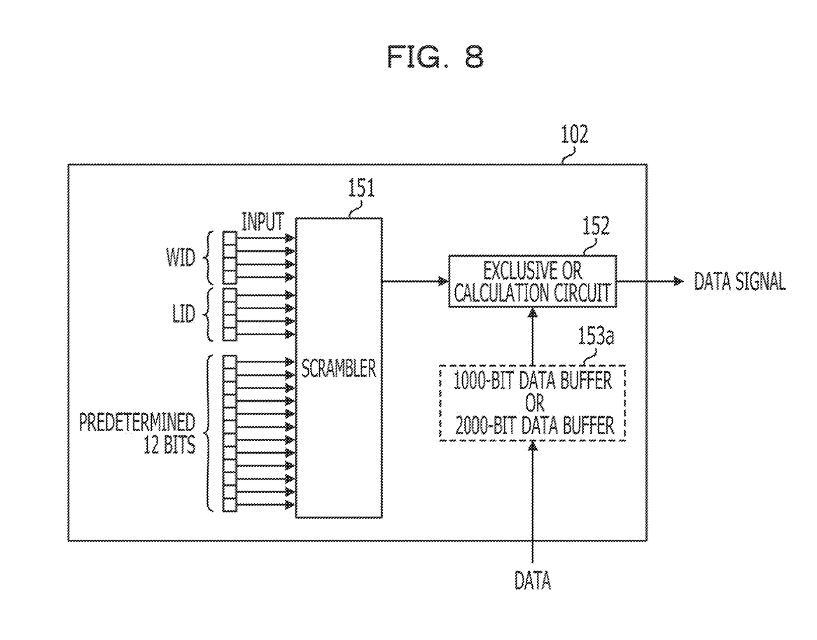

FIG. 8 illustrates an exemplary scrambling circuit. When the transmission device 100 illustrated in FIG. 5A transmits the Data channel, the scrambling circuit illustrated in FIG. 8 scrambles the data. The elements of a scrambling circuit 102 illustrated in FIG. 8 may be substantially the same as or similar to those in the scrambling circuit 102 illustrated in FIG. 6 or FIG. 7. Transmission data such as contents data or the like may be input to a 1000-bit data buffer 153a or a 2000-bit data buffer. The 4 bits of the WID is input to a scrambler 151, and the 4 bits of the LID is further input to the scrambler 151 at the time of local-area broadcast. A certain value for the Data channel may be set in response to a transmission mode, for example, an FFT size. The WID of the scrambling code is used when the Data channel of wide-area broadcast is received, and the WID and the LID of the scrambling code are used when the Data channel of local-area broadcast is received. When the WIC channel or the LIC channel is received before the Data channel is received, the scrambling codes of the WID and the LID may be correctly decoded.

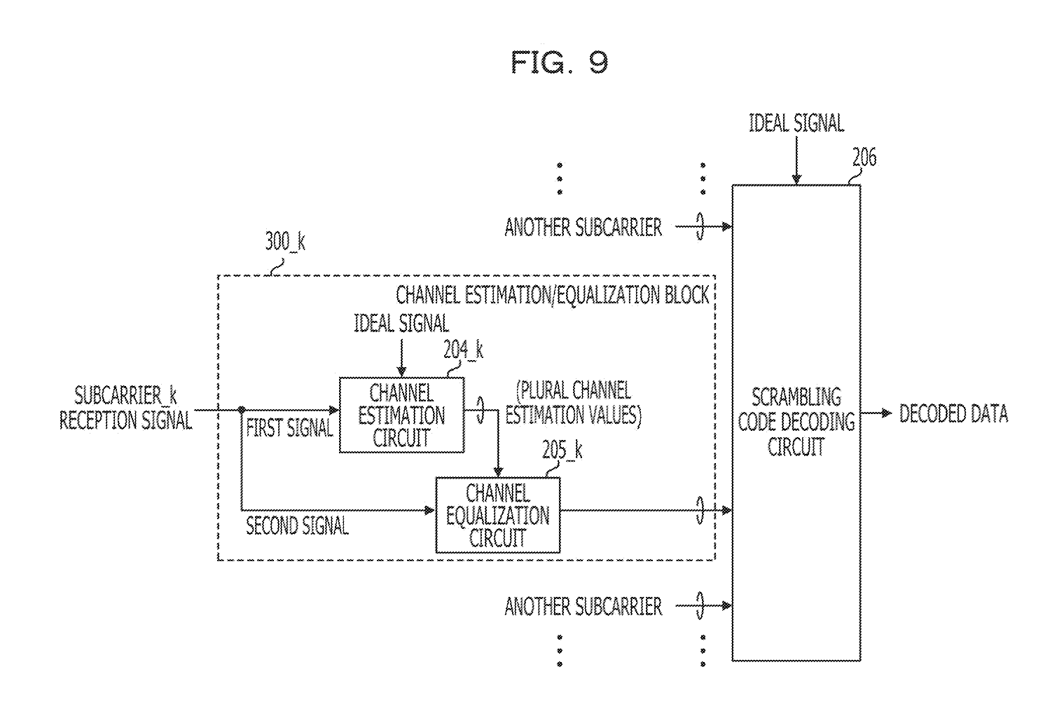

FIG. 9 illustrates an exemplary channel estimation circuit, an exemplary channel equalization circuit, and an exemplary scrambling code decoding circuit. The channel estimation circuit 204, the channel equalization circuit 205, and the scrambling code decoding circuit 206, illustrated in FIG. 5B, may perform an operation illustrated in FIG. 9. In FIG. 9, for example, a subcarrier_k, a k-th subcarrier from among 4096 subcarriers output from the FFT 203, is illustrated. The value “k” may correspond to a carrier number that is one of integers ranging from “1” to “4096”. In MediaFLO, a subcarrier number may be used for each channel.

Subcarriers valid in MediaFLO may be 4000 subcarriers having carrier numbers [48, 49, 50, . . . 2047, 2049, 2050, . . . 4047, and 4048] from among 4096 subcarriers output from the FFT 203. Subcarriers having carrier numbers [0, 1, . . . 47, 2048, 4049, 4050, . . . , and 4095] may not be used.

Subcarriers having subcarrier numbers [64, 96, 128, . . . 2016, 2080, . . . 4000, and 4032] from among 4000 subcarriers, which are used by the TDM1 channel, may be arranged at intervals of 32 subcarriers.

Subcarriers having subcarrier numbers [48, 56, 64, . . . 2040, 2056, . . . , 4040, and 4048], which are used by the WIC channel and the LIC channel, may be arranged at intervals of 8 subcarriers.

Subcarriers having carrier numbers [48, 50, 52, . . . 2046, 2050, . . . , 4046, and 4048], which are used by the TDM2 channel, may be arranged at intervals of 2 subcarriers.

In FIG. 9, the reception signal of the subcarrier_k is input to a channel estimation/equalization block 300_{—}k corresponding to the k-th subcarrier. The channel estimation/equalization block 300_{—}k includes a channel estimation unit 204_{—}k corresponding to the k-th subcarrier and a channel equalization unit 205_{—}k corresponding to the k-th subcarrier. The output signal of the channel estimation/equalization block 300_{—}k is input to a scrambling code decoding unit 206. Similar to the channel estimation/equalization block 300_{—}k, the reception signals of subcarriers other than the subcarrier_k also are input to the scrambling code decoding unit 206 after the channel estimation and the channel equalization.

In FIG. 9, the channel estimation unit 204_{—}k calculates a channel estimation value based on an input first signal. A plurality of ideal signals for the first signal are used as reference signals, and a plurality of channel estimation values are calculated. As illustrated in FIG. 7, the plurality of ideal signals may be known signals. Using the plurality of channel estimation values calculated by the channel estimation unit 204_{—}k, a second signal received with the subcarrier_k is channel-equalized. The first signal and the second signal may be signals received from the same subcarrier_k at different times. The first signal and the second signal may be signals which are scrambled by the scrambling unit 102 on the transmitting side using the same scrambling code. The second signals which are equalized for each subcarrier is output to the scrambling code decoding unit 206.

When a block expressed with the addition of a block code “_k” is expressed, a reception signal whose subcarrier number is “k” may be processed. With respect to a block having no block code “_k”, all subcarriers may be processed.

Using the plurality of ideal signals for the second signal as reference signals, the scrambling code decoding unit 206 evaluates the equalized second signal input from each subcarrier. As illustrated in FIG. 7, the plurality of ideal signals may be known signals. The scrambling code decoding unit 206 outputs, as decoded data, a scrambling code when a subcarrier having the WIC signal satisfies a set condition, for example, a scrambling code when the sum of distances between signal points and the signal points of the ideal signal is minimum.

When a transmission signal is received that is scrambled using one scrambling code from among a plurality of scrambling codes, a signal after the channel equalization is evaluated using a plurality of known signals, and a signal that matches a set condition is determined as an adequate reception signal. For example, in MediaFLO, since all subcarriers for the WIC channel are used in the decoding of the WID, a scrambling code may be decoded with high accuracy.

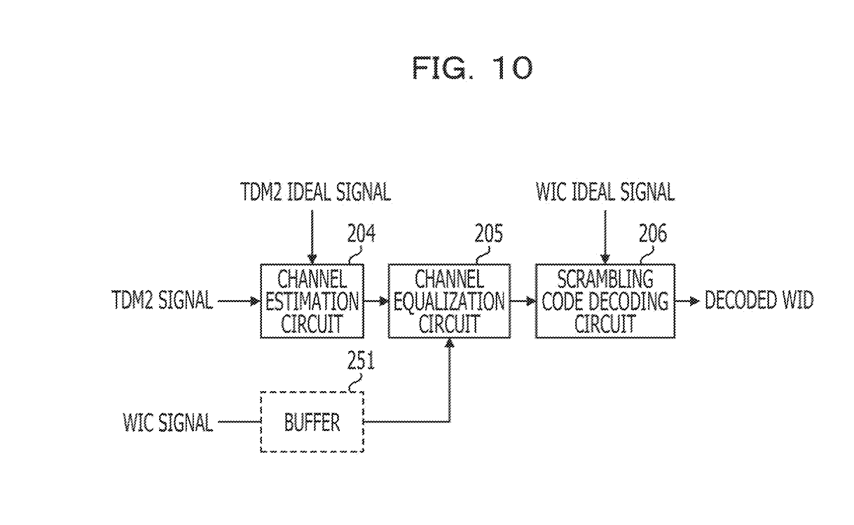

FIG. 10 illustrates an exemplary decoding process. For example, in FIG. 10, a channel estimation circuit 204, a channel equalization circuit 205, and a scrambling code decoding circuit 206 in a reception device decode the WID of the scrambling code. In FIG. 10, the same symbol may be assigned to a element that is substantially the same as or similar to that illustrated in FIG. 5, and the description thereof may be omitted or reduced. For example, as illustrated in FIG. 9, the channel estimation circuit 204 and the channel equalization circuit 205, illustrated in FIG. 10, may channel-estimate using the TDM2 signal for each subcarrier with which the signal of the WIC channel is transmitted, and channel-equalize the signal of the WIC channel.

In FIG. 10, the signal (TDM2 signal) of the TDM2 channel and the signal (WIC signal) of the WIC channel may be included in the same subcarrier as illustrated in FIG. 1. For example, in FIG. 1, the TDM2 signal and the WIC signal are transmitted using subcarriers having subcarrier numbers 64, 72, 80, 88, and 96. A channel estimation value obtained by channel-estimating using the TDM2 signal may be applied to channel equalization for the WIC signal that uses the same subcarrier. As illustrated in FIGS. 1 and 2, since the TDM2 signal is transmitted after the WIC signal is transmitted, a buffer 251 for delay may be disposed to channel-equalize the WIC signal using the channel estimation value calculated based on the TDM2 signal. A buffer for a process not illustrated may be disposed. When a signal corresponding to the TDM2 signal, for example, a signal using the same subcarrier as the WIC signal is transmitted prior to the WIC signal, the buffer 251 for delay may not be disposed.

16 TDM2 signals are generated based on 16 WIDs. 16 WIC signals are generated based on the 16 WIDs. As illustrated in FIG. 10, the ideal signal may be supplied from the outside of the scrambling code decoding unit 206, or generated in the scrambling code decoding unit 206.

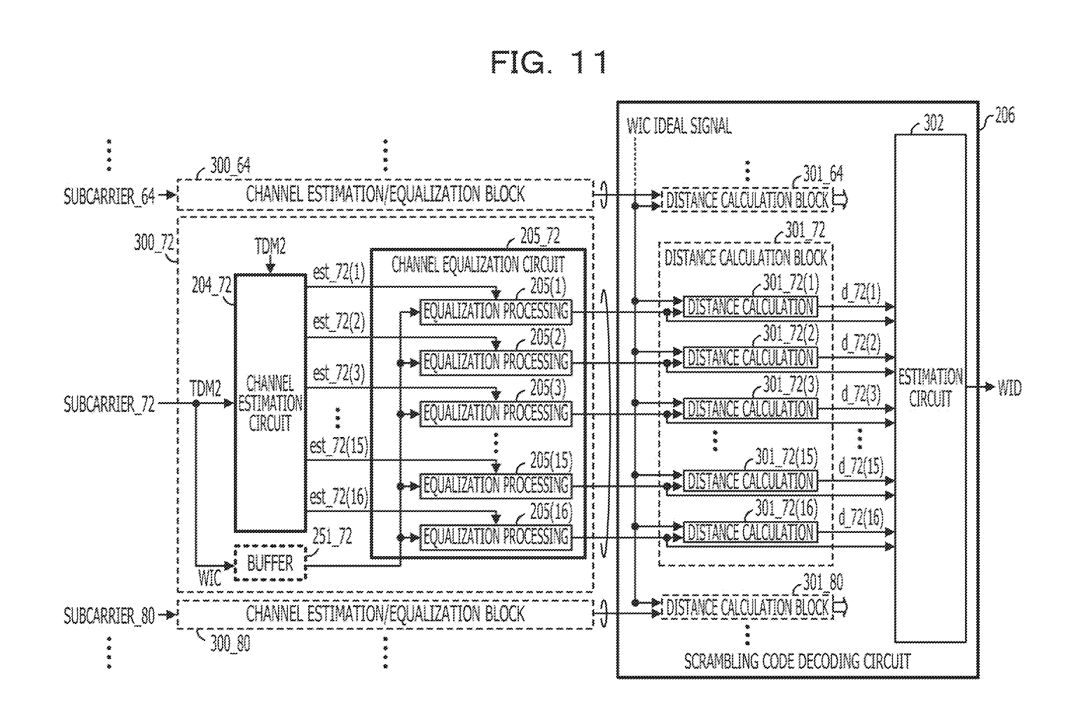

FIG. 11 illustrates an exemplary channel estimation circuit, an exemplary channel equalization circuit, and an exemplary scrambling code decoding circuit. A channel estimation/equalization block 300_72 illustrated in FIG. 11 may correspond to a 72th subcarrier (subcarrier_72). FIG. 11 may illustrate a portion of the scrambling code decoding unit 206. A reception signal using another subcarrier with which the WIC signal is transmitted may also be processed in substantially the same way as the 72th subcarrier. For example, a channel estimation/equalization block 300_64 and a distance calculation block 301_64 in the scrambling code decoding circuit 206 are used for a subcarrier_64. For example, a channel estimation/equalization block 300_80 and a distance calculation block 301_80 in the scrambling code decoding circuit 206 are used for a subcarrier_80.

The TDM2 signal received using the subcarrier_72 is input to the channel estimation unit 204_72, and 16 channel estimation values for the 16 TDM2 ideal signals, for example, values ranging from an est_72(1) to an est_72(16), illustrated in FIG. 11, are calculated. As illustrated in FIG. 3, the channel estimation value est_72 indicates a reception signal and a transmission signal whose amplitude and phase are changed in a propagation line, for example, the amount of amplitude change and the amount of rotational change with respect to the ideal signal, and may be indicated with, for example, a complex number H.

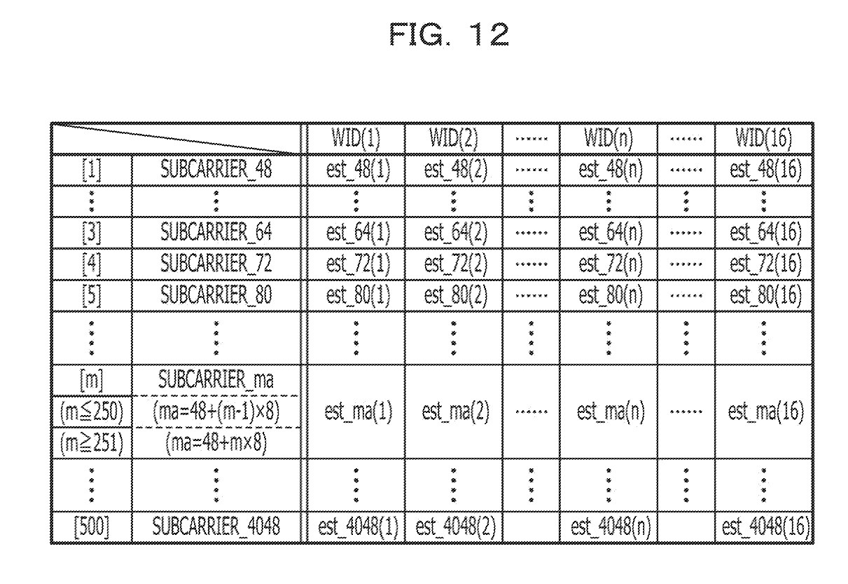

The 16 channel estimation values est_72 are also calculated for the TDM2 signal that uses the same subcarrier as the WIC signal. FIG. 12 illustrates an exemplary channel estimation value. FIG. 12 illustrates a channel estimation value calculated when the number of the subcarriers of the OFDM signal is 4096, for example. Since the WIC channel is allocated to a subcarrier which is arranged at an interval of 8 subcarriers, the WIC signal is transmitted using 500 subcarriers ranging from a subcarrier_48 to a subcarrier_4048. For example, “m” illustrated in FIG. 12 may be one of integers ranging from 1 to 500. The 16 channel estimation values for each subcarrier corresponding to the WIC signal may be expressed as channel estimation values est_ma(1) to est_ma(16). When m≦250, the subcarrier number (ma) is expressed with Equation (1).

ma=48+(m−1)*8 (1)

When m≧251, the subcarrier number (ma) is expressed with Equation (2).

ma=48+m*8 (2)

The 16 channel estimation values for each of the 500 subcarriers are calculated from TDM2 signal having the same subcarrier. For example, “n” illustrated in FIG. 12 may be one of integers ranging from 1 to 16. For example, as illustrated in FIG. 12, with respect to the subcarrier_72, the channel estimation value est_72(1) is calculated for a WID(1), and the channel estimation value est_72(2) is calculated for a WID(2). A channel estimation value est_72(n) is calculated for a WID(n), and the channel estimation value est_72(16) is calculated for a WID(16). Other subcarriers may also be processed in substantially the same way. When the number of the subcarriers is M (M is a natural number), and the number of the types of the scrambling codes is N (N is a natural number), (N*M)=(16*500), namely, 8000 channel estimation values are calculated.

When a block is included in one of 16 types, the block may be expressed with the addition of (block code), for example, (n). The block expressed without the addition of (n) may include all blocks.

The WIC signal received prior to the TDM2 signal with the subcarrier_72 is delayed by a certain time by a buffer 251_72 for delay, and input to a channel equalization unit 205_72. The certain time for delay in the buffer 251_72 may correspond to a time for calculating 16 channel estimation values for the TDM2 signal. The WIC signal delayed by the buffer 251_72 is channel-equalized by the channel equalization unit 205_72. The channel equalization unit 205_72 includes equalization process circuits provided for 16 channel estimation values, for example, an equalization process circuit 205(1) to an equalization process circuit 205(16), and the WIC signal output from the buffer 251_72 is channel-equalized.

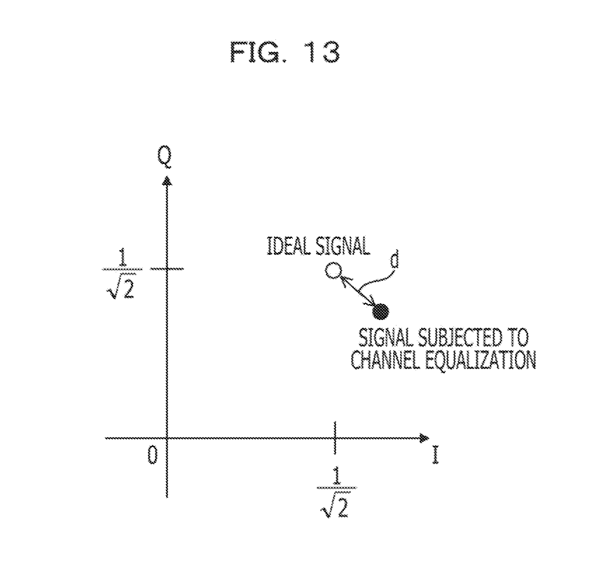

The 16 signals which are channel-equalized by the channel equalization circuit 205_72 are input to a distance calculation block 301_72 in the scrambling code decoding unit 206. The distance calculation block 301_72 includes 16 distance calculation circuits 301_72(1) to 301_72(16) corresponding to the 16 equalized WIC signals, respectively, and the 16 ideal signals of the WIC signal are input to the distance calculation circuits 301_72(1) to 301_72(16), respectively. FIG. 13 illustrates an exemplary distance between an ideal signal point and an equalized-signal point. As illustrated in FIG. 13, a distance between the signal point of the ideal signal of the WIC signal on a complex plane and the signal point of the channel-equalized WIC signal on a complex plane is calculated. In FIG. 13, the ideal signal point is set to a coordinate point located at 1/√2 on an I axis and 1/√2 on a Q axis, and a distance between the two signal points may correspond to the square root of sum of squares of differences on the I axis and the Q axis.

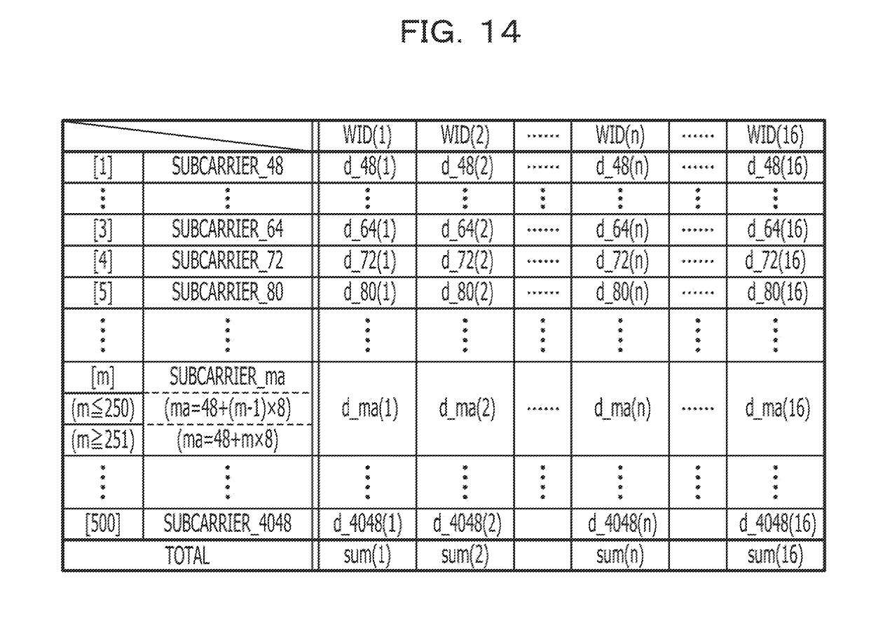

FIG. 14 illustrates an exemplary distance. Similar to the channel estimation values est illustrated in FIG. 12, when the number of the subcarriers of the OFDM signal is 4096 for example, 8000 (=16*500) distances d may be calculated as illustrated in FIG. 13 with respect to 16 distances d for each subcarrier. For example, as illustrated in FIG. 14, in the subcarrier_72, a distance d_72(1) is calculated for the WID(1), and a distance d_72(2) is calculated for the WID(2). A distance d_72(n) is calculated for the WID(n), and a distance d_72(16) is calculated for the WID(16).

Distances for each subcarrier corresponding to the WIC signal may be expressed as distances d_ma(1) to d_ma(16). The subcarrier number (ma) is given according to the value of “m” in accordance with Equation (1) or Equation (2).

An evaluation circuit 302 in the scrambling code decoding circuit 206 determines a WID whose distance d from among distances d corresponding to the 16 types of the WIDs for each subchannel matches a condition, for example, a WID having a minimum sum of distances between the signal points and the signal points of the ideal signal, and decodes the WID.

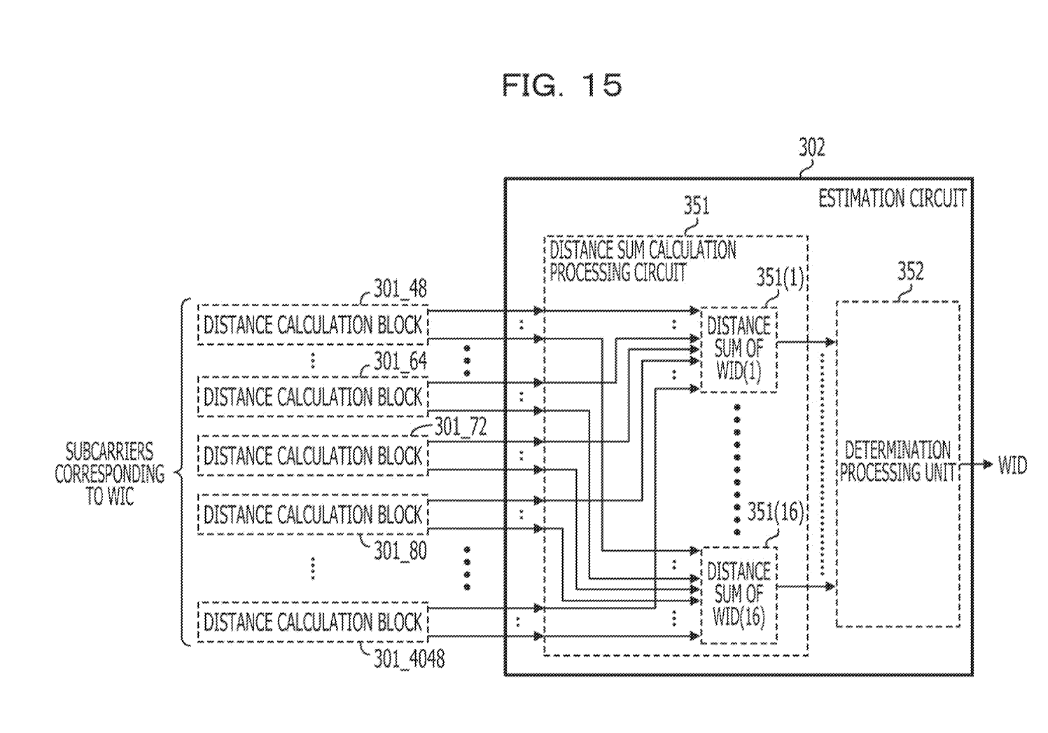

FIG. 15 illustrates an exemplary evaluation circuit. The 16 distances d are input to the evaluation circuit 302, the 16 distances d being calculated by each of 500 distance calculation blocks ranging from a distance calculation block 301_48 to a distance calculation block 301_4048, each of which corresponds to each subcarrier. The evaluation circuit 302 includes a distance sum calculation process unit 351 and a determination process unit 352. For each of the 16 types of the WIDs, the distance sum calculation process operation circuit 351 calculates the sum of the distances d of all subcarriers corresponding to the WIC channel, for example, the sum of the distances d of the 500 subcarriers in FIGS. 12 and 14. For example, in FIG. 14, with respect to the WID(1), the sum sum(1) of the distances d of subcarriers corresponding to the WIC channel, for example, the distances d of from a subcarrier_48 to a subcarrier_4048, for example, the sum of from a distance d_48(1) to a distance d_4048(1), is calculated. With respect to the WID(2), the sum sum(2) of distances d of the subcarriers corresponding to the WIC channel is calculated. With respect to the WID(n), a sum sum(n) is calculated, and with respect to the WID(16), a sum sum(16) is calculated.

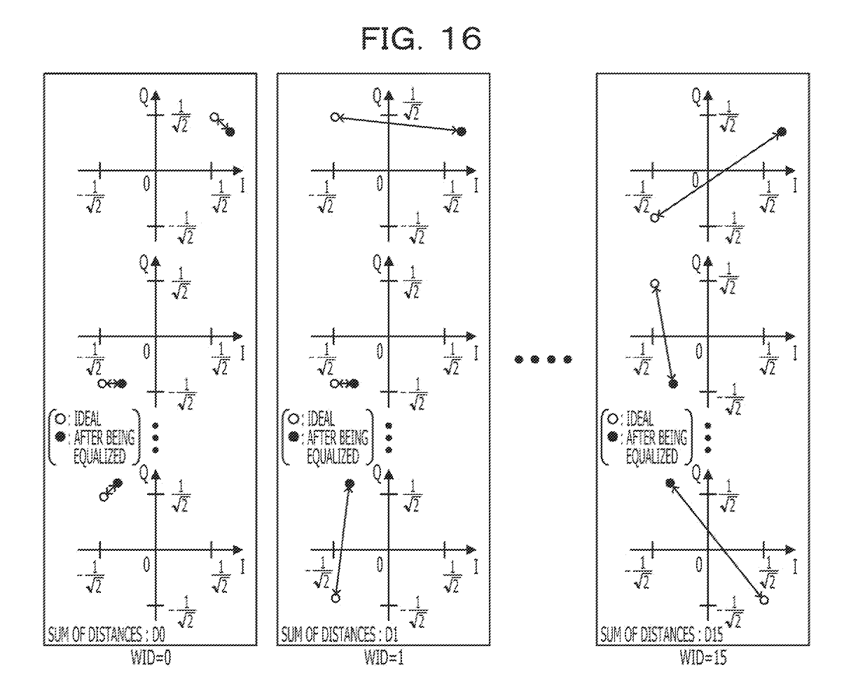

FIG. 16 illustrates an exemplary distance calculation method. In FIG. 16, distances d are calculated in accordance with the 16 types of the WIDs. As illustrated in FIG. 16, distances d corresponding to the 16 types of the WID, respectively, are calculated.

The 16 sums of distances are input to the determination process circuit 352 in the evaluation circuit 302. The determination process circuit 352 outputs, as a decoded WID, a WID having a minimum sum of distances. For example, in FIG. 14, when the sum(2) that is the sum of distances of the WID(2) is a minimum among from sum(1) to sum(16), the determination process circuit 352 may output the WID(2) as a decoded WID.

When a signal is scrambled using one scrambling code of the 16 types of the scrambling codes WID and a transmitted signal is received, channel estimation, channel equalization, and the decoding of the scrambling code are performed since the TDM2 signal is regarded as 16 known signals. The number of the subcarriers of the WIC channel used for decoding the WID is increased, and hence the scrambling code is decoded with high accuracy.

The above-mentioned embodiment may be applied to a reception device which decodes a scrambling code from a transmission signal scrambled with an unknown scrambling code.

Since the result of channel equalization performed in response to the plurality of types of scrambling codes is evaluated, and a scrambling code that matches a condition, for example, a scrambling code having a minimum sum of distances between signal points and the signal points of the ideal signal is decoded, the unknown scrambling code is decoded with high accuracy.

In MediaFLO, the LID is decoded by channel-equalizing the signal of a subcarrier used for transmitting the LIC channel.

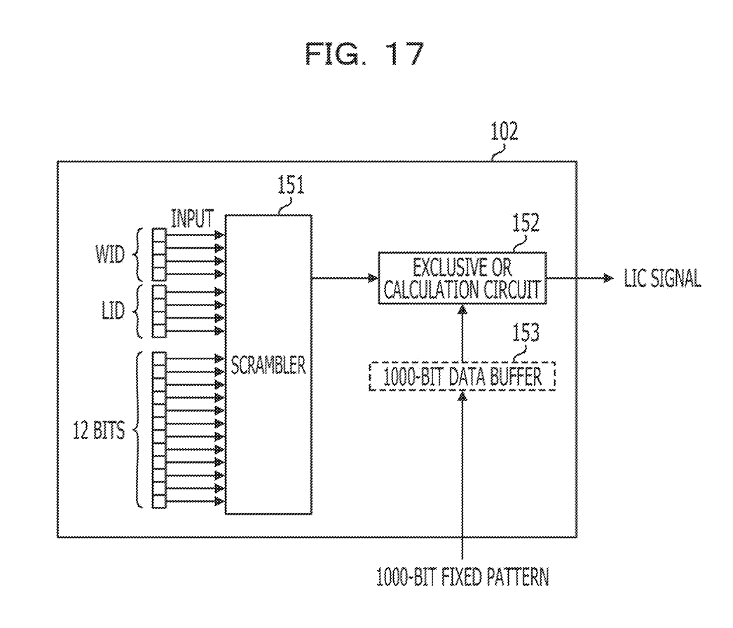

FIG. 17 illustrates an exemplary scrambling circuit. In FIG. 17, the transmission device 100 may transmit the LIC channel. In FIG. 17, the configuration of the scrambling circuit 102 may be substantially the same as or similar to that of the scrambling circuit illustrated in FIG. 6. The scrambling circuit 102 includes a scrambler 151, an exclusive OR calculation unit 152, and a 1000-bit data buffer 153. The WID and the LID may be input to the scrambler 151, and the number of bits for the LIC channel may be 12. The WID of the scrambling code may be substantially the same as the WID transmitted through the WIC channel in the same super frame. 12 bits for the LIC channel may be known, and the WID may also be known when the WID is decoded from the signal of the WIC channel before the LIC channel is received. Since “0” is set in the 1000-bit data buffer, the LIC channel generated in the scrambling unit 102 may correspond to 16 signals which are substantially the same as those in the LID.

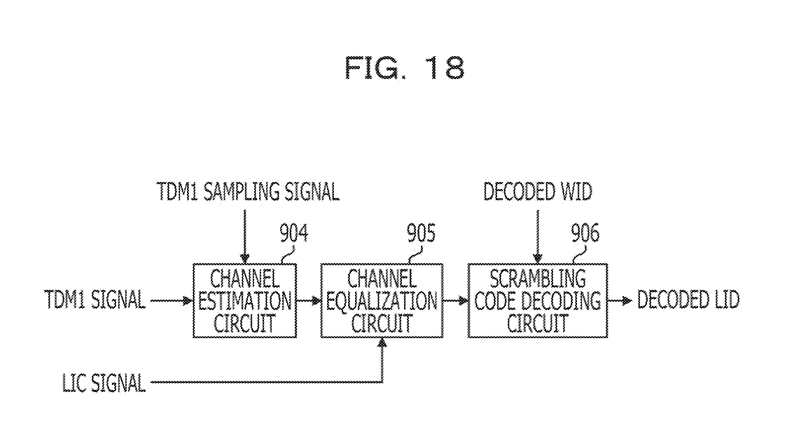

FIG. 18 illustrates an exemplary decoding process. In FIG. 18, the decoding of the LID is performed. FIG. 18 may correspond to the WID decoding process illustrated in FIG. 4. The channel estimation circuit 904 channel-estimates based on the reception signal of the TDM1 channel that is a known signal transmitted at the start of the super frame, and the channel equalization unit 905 channel-equalizes the reception signal of the LIC channel using the channel estimation value. The scrambling code decoding unit 906 decodes a scrambling code (LID) based on the channel-equalized signal of the LIC channel and the previously decoded WID.

As illustrated in FIG. 1, the subcarriers of the LIC channel are arranged at intervals of 8 subcarriers similar to the WIC channel. When the channel estimation is performed based on the subcarriers of the TDM1 channel, which is arranged at intervals of 32 subcarriers, the signal of the LIC channel of a subcarrier located at substantially the same position as the TDM1 channel is channel-equalized.

The LIC signal is channel-equalized using 16 channel estimation values channel-estimated based on the TDM2 signal, and an LID that matches a condition, for example, a LID having a minimum sum of distances between the signal points thereof and the signal points of the ideal signal, is discerned from among the 16 types of the LIDs, and the LID is decoded.

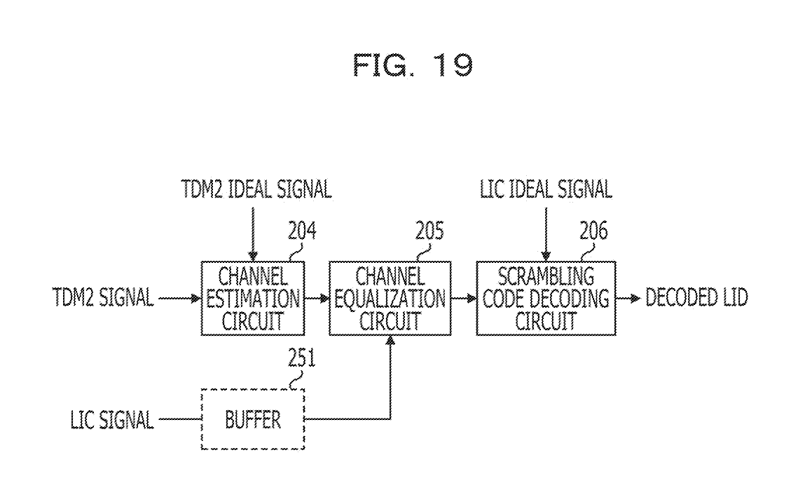

FIG. 19 illustrates an exemplary decoding process. In FIG. 19, for example, the LID is decoded by the channel estimation unit 204, the channel equalization unit 205, and the scrambling code decoding unit 206 in the reception device. In FIG. 19, the same symbol may be assigned to an element that is substantially the same as or similar to that illustrated in FIG. 4. As illustrated in FIG. 9, the channel estimation unit 204 and the channel equalization unit 205 calculate a channel estimation value based on the signal of the TDM2 channel corresponding to each subcarrier with which the signal of the LIC channel is transmitted, and channel-equalize the signal of the LIC channel using the channel estimation value.

In FIG. 19, the signal (TDM2 signal) of the TDM2 channel and the signal (LIC signal) of the LIC channel use the same subcarriers. For example, the TDM2 signal and the LIC signal illustrated in FIG. 1 are transmitted using the subcarriers having the subcarrier numbers 64, 72, 80, 88, and 96. A channel estimation value channel-estimated based on the TDM2 signal may be applied to channel equalization of the LIC signal transmitted using the same subcarriers. Since, similar to the WIC signal, the TDM2 signal is transmitted following the LIC signal, the buffer 251 for delay is disposed in order to channel-equalize the LIC signal based on the channel estimation value calculated using the TDM2 signal.

In FIG. 19, since the TDM2 signal is generated using the 16 types of the WIDs, the number of the ideal signals of the TDM2 signal may be 16. Since the LIC signal is generated using the 16 types of the LIDs, the number of the ideal signals of the LIC signal may be 16. The WID may be known. The ideal signals may be supplied from the outside of the scrambling code decoding unit 206, or generated in the scrambling code decoding unit 206. In addition, the ideal signal generation circuit may be provided outside.

In FIG. 19, the WIC signal illustrated in FIG. 10 may be replaced with the LIC signal, and the WID illustrated in FIG. 10 may be replaced with the LID. For example, in FIG. 11, FIG. 12, FIG. 14, FIG. 15, FIG. 13, and FIG. 16, the WIC signal may be replaced with the LIC signal, and the WID may be replaced with the LID. For example, the distance calculation block 301 in the scrambling code decoding circuit 206 illustrated in FIG. 15 calculates a distance between the equalized LIC signal and the ideal signal of the LIC channel for each subchannel through which the LIC signal is transmitted. The distance sum calculation process operation circuit 351 in the evaluation circuit 302 in the scrambling code decoding circuit 206 calculates sum(1) to sum(16), which correspond the sums of distances of subchannels through which the LIC signal is transmitted, for an LID(1) to an LID(16), respectively. The determination process circuit 352 in the evaluation circuit 302 in the scrambling code decoding circuit 206 outputs, as a decoded LID, a LID having a minimum sum of distances.

The above-mentioned embodiment may be applied to a reception device which decodes a scrambling code from a transmission signal scrambled with an unknown scrambling code.

Since the result of channel equalization according to the plurality of types of scrambling codes is evaluated, and a scrambling code that matches a condition, for example, a scrambling code having the minimum sum of distances between signal points and the signal points of the ideal signal is decoded, the unknown scrambling code is decoded with high accuracy.

In MediaFLO, the signal of a subcarrier used for transmitting the LIC channel is channel-equalized, and the WID and the LID are decoded.

The processes from a process in which the LIC signal is channel-equalized based on 16 channel estimation values channel-estimated based on the TDM2 signal to a process in which the 16 equalized LIC signals are evaluated may be substantially the same as or similar to the processes illustrated in FIG. 19.

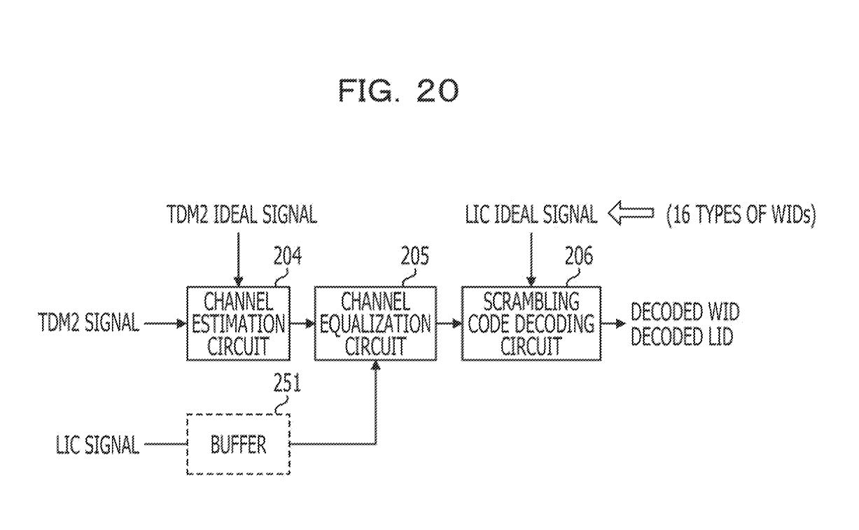

FIG. 20 illustrates an exemplary decoding process. In FIG. 20, the WID and the LID of the scrambling code may be decoded by the channel estimation circuit 204, the channel equalization circuit 205, and the scrambling code decoding circuit 206 in the reception device 200. In FIG. 20, the same symbol may be assigned to an element that is substantially the same as or similar to that illustrated in FIG. 5 or 19. The channel estimation circuit 204 and the channel equalization circuit 205 illustrated in FIG. 20 may perform an operation that is substantially the same as or similar to the operation illustrated in FIG. 19. Since the WID is unknown, the 256 types of ideal signals of the LIC channel are generated based on the 16 types of the WIDs and the 16 types of the LIDs. The ideal signals may be supplied from the outside of the scrambling code decoding circuit 206, or generated in the scrambling code decoding circuit 206. In addition, the ideal signal generation circuit may be provided externally.

The distance calculation block 301 in the scrambling code decoding circuit 206 calculates distances between the 256 types of ideal signals and the equalized LIC signal for each subcarrier. For example, distances between the equalized LIC signal and the 256 types of ideal signals, a WID·LID(1) to a WID·LID(256), may be calculated in place of the WID(1) to the WID(16) for each subcarrier, the 256 types of ideal signals being obtained by combining the 16 types of the WIDs with the 16 types of the LIDs. The distance sum calculation process operation circuit 351 in the evaluation circuit 302 in the scrambling code decoding circuit 206 calculates sum(1) to sum(256) corresponding to the sums of distances of subchannels used for transmitting the LIC signal for each of the WID·LID(1) to the WID·LID(256). The determination process circuit 352 in the evaluation circuit 302 in the scrambling code decoding circuit 206 outputs a WID and an LID as a decoded WID and a decoded LID respectively, the WID and the LID corresponding to the combination of a WID and an LID from among the 256 combinations of the WIDs and the LIDs having the minimum sum of distances.

The 16 channel estimation values are calculated from the TDM2 signal, the 16 types of LIC signal obtained by channel-equalized the LIC signal is evaluated based on the 256 types of LIC ideal signals, and the WID and the LID are decoded.

When a signal, which is scrambled using one scrambling code based on the combinations of the 16 types of the WIDs and the 16 types of the LIDs, is received, the TDM2 signal is regarded as 16 known signals, and channel estimation, channel equalization, and the decoding of the scrambling code are performed. Since the number of the subcarriers of the LIC channel used for decoding the WID and the LID is increased, the scrambling code is decoded with high accuracy. Since the WID and the LID are decoded together, the number of process times is reduced.

The number of the subcarriers may be M (M is an integer greater than or equal to 2). The number of the types of the WIDs and the LIDs may be N (N is an integer greater than or equal to 2).

The above-mentioned embodiment may be applied to a reception device used in a communication system which uses a plurality of scrambling codes.

A plurality of types of unknown scrambling codes are collectively decoded from a transmission signal scrambled using the plurality of types of unknown scrambling codes.

Since a scrambling code when the evaluation result of channel equalization based on the plurality of types of scrambling codes matches a condition, for example, a scrambling code having a minimum sum of distances between signal points and the signal points of the ideal signal is decoded, the plurality of types of the unknown scrambling codes are decoded with high accuracy. The scrambling code may be decoded using software such as a CPU used for controlling the reception device, or the like.

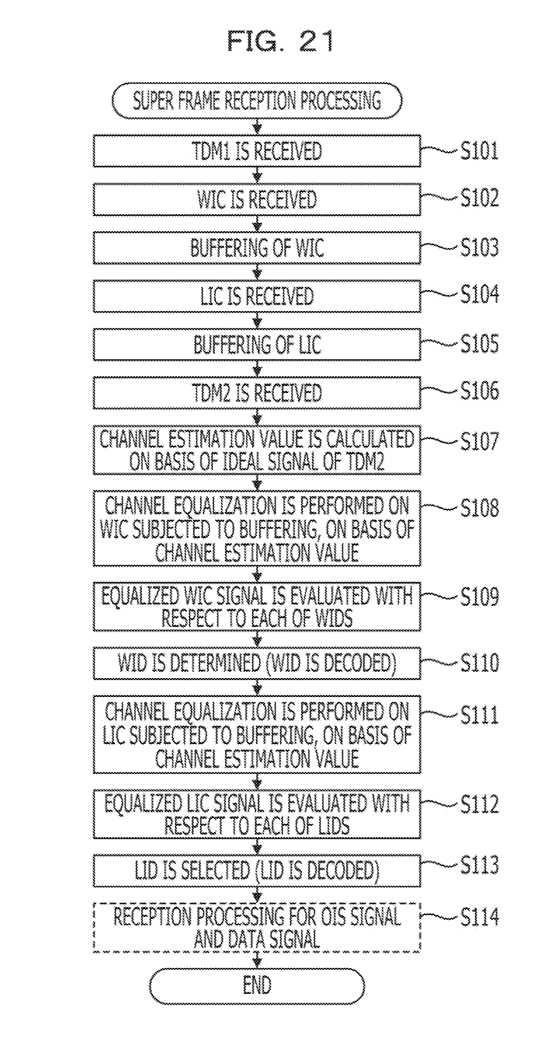

FIG. 21 illustrates an exemplary super frame reception process. The super frame illustrated in FIG. 2 may be a super frame used in MediaFLO.

In an operation S101, the TDM1 signal indicating the start of the super frame is received.

In an operation S102, the WIC signal is received.

In an operation S103, the WIC signal is buffered by a buffer. The buffer 251 may correspond to a storage area reserved on a memory with software.

In an operation S104, the LIC signal is received.

In an operation S105, the LIC signal is buffered by a buffer. The buffer may correspond to a storage area reserved on a memory with software.

In an operation S106, the TDM2 signal is received.

In an operation S107, 16 channel estimation values are calculated for the TDM2 signal based on the 16 ideal signals of the TDM2.

In an operation S108, the WIC signal which is buffered by the buffer in the operation S103, is channel-equalized based on the 16 channel estimation values calculated in the operation S107.

In an operation S109, the WIC signal equalized for each of the 16 types of the WIDs is evaluated using an evaluation method.

In an operation 5110, the WID is decoded. For example, the WID evaluated highly in the operation S109 is set as the decoded WID.

In an operation S111, the decoding of the LID is started. The LIC signal buffered by the buffer in the operation S105 is channel-equalized based on the 16 channel estimation values calculated in the operation S107.

In an operation S112, the LIC signal equalized for each of the 16 types of the LIDs is evaluated using a evaluation method. The WID decoded in the operation S110 may be used.

In an operation S113, the LID is decoded. For example, the LID evaluated highly in the operation S112 is set as the decoded LID.

In an operation S114 or later, an OIS signal and a Data signal, which are input subsequently, are received using the WID and the LID of the decoded scrambling code, and the reception of one super frame is terminated.

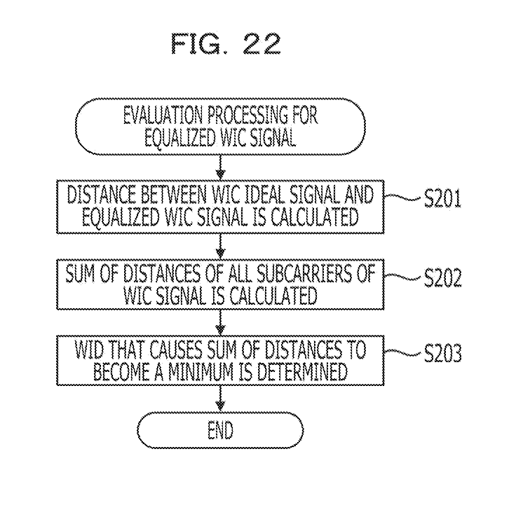

FIG. 22 illustrates an exemplary evaluation process. The evaluation process illustrated in FIG. 22 may correspond to the operation S109 illustrated in FIG. 21.

In an operation S201, a distance between the signal point of the WIC signal equalized for each of the 16 types of the WIDs and the signal point of the ideal signal of the WIC is calculated on a complex plane.

In an operation S202, the sum of distances of the subcarriers of the WIC signal is calculated for each of the 16 types of the WIDs.

In an operation S203, a WID having a minimum sum of distances of all subcarriers of the WIC signal is determined from among the 16 types of the WIDs.

The WID evaluated highly from among the 16 types of the WIDs is set as the decoded WID.

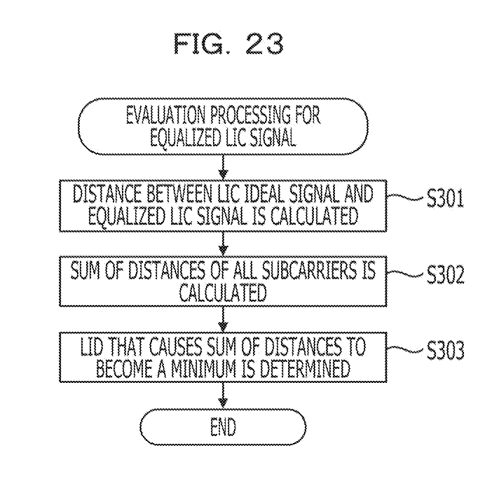

FIG. 23 illustrates an exemplary evaluation process. The evaluation process illustrated in FIG. 23 may correspond to the operation S112 illustrated in FIG. 21.

In an operation S301, a distance between the signal point of the LIC signal equalized for each of the 16 types of the LIDs and the signal point of the ideal signal of the LIC is calculated on a complex plane.

In an operation S302, the sum of distances of the subcarriers of the LIC signal is calculated for each of the 16 types of the LIDs.

In an operation S303, a LID having a minimum sum of distances of all subcarriers of the LIC signal is determined from among the 16 types of the LIDs.

The LID evaluated highly from among the 16 types of the LIDs is decoded.

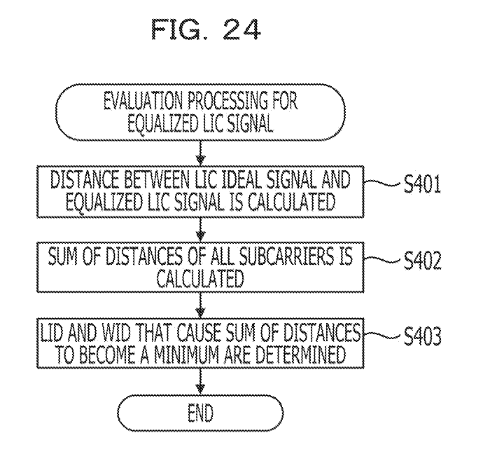

FIG. 24 illustrates an exemplary evaluation process. In FIG. 24, the WID and the LID are decoded together. The process for decoding the WID from the WIC signal, illustrated in FIG. 21, for example, the operation S108, S109, or S110 may not be performed.

In an operation S401, a distance between the signal point of the equalized LIC signal and the signal point of the ideal signal of the LIC is calculated on a complex plane, for each of the 256 combinations of the 16 types of the WIDs and the 16 types of the LIDs.

In an operation S402, the sum of distances of the subcarriers of the LIC signal is calculated for each of the 256 combinations of the WIDs and the LIDs.

In an operation S403, a combination of a WID and a LID having a minimum sum of distances of subcarriers of the LIC signal is determined from among the 256 combinations of the WIDs and the LIDs.

The combination of the WID and the LID evaluated highly from among the 256 combinations of the WIDs and the LIDs is set as the decoded WID and the decoded LID.

In the reception device 200 that performs software process, by regarding a signal, which is scrambled using one scrambling code from among a plurality of scrambling codes and is transmitted, as a plurality of known signals, a channel-equalized signal evaluated, and a reception signal evaluated highly is determined. For example, in MediaFLO, since the number of the subcarriers of the WIC channel used for decoding the WID is increased, the scrambling code is decoded with high accuracy. The decoding of the LID or the decoding of the WID and the LID also is similar.

An equalized signal is evaluated using a distance between the signal point thereof and the signal point of an ideal signal. For example, a scrambling code having a maximum correlation value between the equalized signal and the ideal signal may be decoded.

The above-mentioned embodiment may be applied to a reception device used in a communication system or a broadcast system in which data scrambled using one scrambling code of a plurality of scrambling codes is transmitted.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. A reception device comprising:
a channel estimation circuit to receive a first signal scrambled by one of N scrambling codes and transmitted through M carriers having different frequencies, and calculate N channel estimation values corresponding to N types of first specified signals based on the first signal, where N is an integer greater than or equal to 2, where M is an integer greater than or equal to 2;
a channel equalization circuit to channel-equalize a second signal, which is transmitted using the one of N scrambling codes and the M carriers, based on the N channel estimation values; and
a scrambling code decoding circuit to evaluate (N*M) equalized second signals based on N types of second specified signals and decode a scrambling code of the second signal from among the N scrambling codes.

2. The reception device according to claim 1, further comprising,
a distance calculation circuit to calculate distances between signal points of the (N*M) equalized second signals and signal points of the N types of the second specified signals on a complex plane for each of the M carriers, and calculate a sum of the distances of the M carriers for each of the N scrambling codes.

3. The reception device according to claim 1, further comprising,
a determination circuit to determine a scrambling code having a minimum sum of distances.

4. The reception device according to claim 1, wherein
the M carriers include an Orthogonal Frequency-Division Multiplexing (OFDM) subcarrier.

5. The reception device according to claim 1, further comprising,
a buffer to hold the second signal until the channel estimation values are calculated,
wherein the first signal is transmitted behind the second signal.

6. The reception device according to claim 1, wherein
the channel equalization circuit channel-equalizes a third signal for each of the M carriers using P channel estimation values when the scrambling code of the second signal and the third signal, which is scrambled using one of P scrambling codes different from the scrambling code of the second signal, is transmitted through the M carriers, P being an integer greater than or equal to 2, and
the scrambling code decoding circuit calculates distances between signal points of the (P*M) equalized third signals and signal points of the P types of third specified signals based on the scrambling code of the second signal on a complex plane for each of the M carriers, and decodes a scrambling code of the third signal having a minimum sum of the M distances for each of the P scrambling codes.

7. The reception device according to claim 1, wherein
the channel equalization circuit channel-equalizes a third signal for each of the M carriers using P channel estimation values when the scrambling code of the second signal and the third signal, which is scrambled using one of P scrambling codes different from the scrambling code of the second signal, is transmitted through the M carriers, P being an integer greater than or equal to 2, and
the scrambling code decoding circuit calculates distances between signal points of the (P*M) equalized third signals and signal points of the P types of third specified signals based on the scrambling code of the second signal on a complex plane for each of the M carriers, and decodes the scramble code of the second signal and a scrambling code of the third signal which have a minimum sum of the M distances for each of the P scrambling codes.

8. A scrambling code decoding method comprising:
receiving a first signal, which is scrambled by one of N scrambling codes and is transmitted through M carriers having different frequencies, where N is an integer greater than or equal to 2), where M is an integer greater than or equal to 2;
calculating N channel estimation values for N types of first specified signals of the first signal based on the first signal;
channel-equalizing the a second signal, which is transmitted using the one of N scrambling codes and the M carriers, using the N channel estimation values;
evaluating the (N*M) equalized second signals based on N types of ideal signals of the second signal for each of the N scrambling codes; and
decoding a scrambling code of the second signal from among the N scrambling codes based on an evaluation result.

9. The scrambling code decoding method according to claim 8, further comprising,
calculating distances between signal points of the (N*M) equalized second signals and signal points of the N types of the second specified signals on a complex plane for each of the M carriers, and calculate a sum of the distances of the M carriers for each of the N scrambling codes.

10. The scrambling code decoding method according to claim 9, further comprising,
determining a scrambling code having a minimum sum of distances.

11. The scrambling code decoding method according to claim 8, wherein
the M carriers include an Orthogonal Frequency-Division Multiplexing (OFDM) subcarrier.

12. The scrambling code decoding method according to claim 8, further comprising:
channel-equalizing a third signal for each of the M carriers using P channel estimation values when the scrambling code of the second signal and the third signal, which is scrambled using one of P scrambling codes different from the scrambling code of the second signal, is transmitted through the M carriers, P being an integer greater than or equal to 2;
calculating distances between signal points of the (P*M) equalized third signals and signal points of the P types of third specified signals based on the scrambling code of the second signal on a complex plane for each of the M carriers; and
decoding a scrambling code of the third signal having a minimum sum of the M distances for each of the P scrambling codes.

13. The scrambling code decoding method according to claim 8, further comprising:
channel-equalizing a third signal for each of the M carriers using P channel estimation values when the scrambling code of the second signal and the third signal, which is scrambled using one of P scrambling codes different from the scrambling code of the second signal, is transmitted through the M carriers, P being an integer greater than or equal to 2;
calculating distances between signal points of the (P*M) equalized third signals and signal points of the P types of third specified signals based on the scrambling code of the second signal on a complex plane for each of the M carriers; and
decoding the scramble code of the second signal and a scrambling code of the third signal which have a minimum sum of the M distances for each of the P scrambling codes.
